(19) United States
(12) Patent Application Publication
(10) Pub. No.: US 2006/0061344 A1
(43) Pub. Date: Mar. 23, 2006

(54) Control mode discrimination circuit for automotive generator voltage regulator

(75) Inventor: Scott R. Wilson, Novi, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/947,560

(22) Filed: Sep. 22, 2004

(51) Int. Cl. G05F 1/40

(52) U.S. Cl. 323/284

(57) ABSTRACT

An automotive voltage regulator that operates in both an active and passive mode is provided. The voltage regulator includes an input node, a comparator circuit, and a counter circuit. The input node is configured to receive a control signal. The comparator circuit is in communication with the input node and configured to determine if a passive mode signal has been received. The counter circuit is in communication with the input node and configured to control a voltage set point based on an active mode signal.

### BACKGROUND

1. Field of the Invention

The present invention generally relates to an automatic voltage regulator. More specifically, the invention relates to an automotive voltage regulator that operates in active and passive modes.

2. Description of Related Art

Generally, two types of voltage regulators are used for automotive applications. One type is a passively controlled regulator. The passively controlled regulator receives a control signal that receives a simple on/off command based on the voltage level. If the control signal is high, typically between 10 and 18 volts, the regulator determines the voltage set point based on the regulator temperature. If the voltage signal is low, typically around 0 volts, the regulator is de-activated.

The second type of voltage regulator is an actively controlled voltage regulator. As its name implies, an actively controlled voltage regulator receives a control signal that actively controls the voltage set point. The control signal is a pulse width modulated control signal where the voltage level of the signal oscillates between 0 and 3.3 volts. The duty cycle of the signal controls the voltage set point of the regulator.

Typically, the passive regulator utilizes a pull-up interface circuit, and the active regulator utilizes a pull-down interface circuit. As such, a separate regulator is used to operate in either the active mode or passive mode.

The pull-up interface circuit interfaces with the base of an NPN bi-polar transistor to turn on the passively controlled regulator. The pull-down interface circuit is coupled with a logic level inverter, with hysteresis and a resistor pull-up at its input to provide the vehicle voltage level, thereby actively manipulating the regulator. Currently, regulators have either a pull-up circuit or pull-down interface circuit, therefore, separate regulators are used in each application.

In view of the above, it is apparent that there exists a need for an automotive voltage regulator that can operate in both an active and passive mode.

### SUMMARY

In satisfying the above need, as well as, overcoming the enumerated drawbacks and other limitations of the related art, the present invention provides an automotive voltage regulator that can alternately operate in either an active or passive mode.

The voltage regulator includes an input node, a comparator circuit, and a counter circuit. The input node is configured to receive a control signal. The comparator circuit is in communication with the input node and configured to determine if a passive or active mode signal has been received. If an active mode signal is received, the counter circuit, which is in communication with the input node, is configured to control a voltage set point.

In another aspect of the present invention, the comparator circuit includes a comparator with a first input connected to the input node and a second input connected to a voltage source. The voltage source provides a voltage less than the lowest expected vehicle level pull-up and greater than logic levels used for the active mode signal. As such, the comparator circuit has a threshold level of about 8 volts, that is less than the lowest expected vehicle pull-up, but greater than the logic levels used for the active mode signal.

In another aspect, the voltage regulator includes a diode isolated pull-up circuit. The diode isolated pull-up circuit includes a diode, a resistor, and a voltage source where the diode and resistor are in electrical series connection between the input node and the voltage source. The voltage source provides a bias voltage, of about 6 volts, that is greater than the active mode logic high threshold but less than the comparator threshold, used for detecting the passive mode signal.

In still another aspect, the voltage regulator includes a logic level inverter with hysteresis is electrically connected between the input node and the counter circuit. Further, the counter circuit is configured to enter a sleep mode if a time out is reached after receiving an active mode signal.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a voltage regulator in accordance with the present invention.

### DETAILED DESCRIPTION

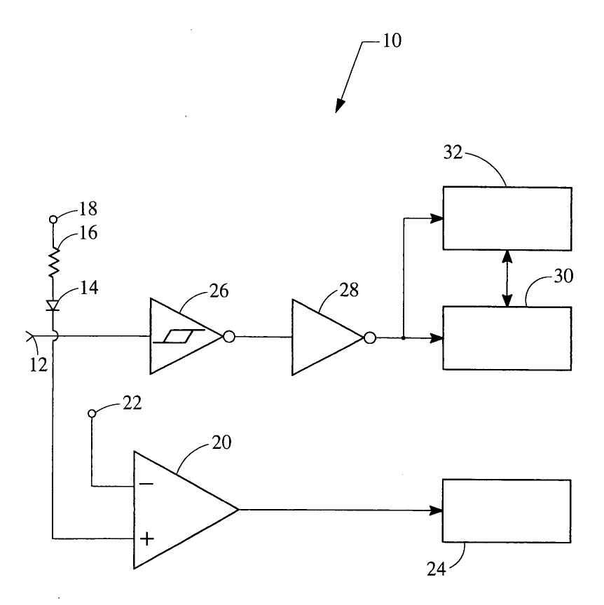

Referring now to FIG. 1, a voltage regulator embodying the principles of the present invention is illustrated therein and designated at 10. As its primary components, the voltage regulator 10 includes an input node 12, a diode 14, a resistor 16, and a comparator 20.

The voltage regulator 10 analyzes a control signal to discriminate between either a pull-up interface for passive (on/off) regulator control or a pull-down interface for active regulator control. The control signal can be provided from a variety of sources; one example of which is a power train control module (not shown). The input node 12 receives the control signal and is connected to the comparator 20 for detecting a passive control mode. The threshold level of the comparator 20 is set at a value that is less than the lowest expected vehicle level pull-up, but greater than the logic levels used for the active control mode. As such, the voltage signal from the input node 12 is provided to the positive input of the comparator 20 and the negative side of the comparator 20 is connected to a voltage source 22. The voltage source 22 is set to about 8 volts. In passive mode, the power train control module pulls up the regulator's input circuit to the vehicle system voltage (10 volts-18 volts) to turn on the regulator. Therefore, 8 volts is used as the threshold level for the comparator 20 to detect a pull-up to the vehicle system voltage. The output of the comparator 20 is provided to a mode logic block 24 that determines the operation mode based on the output of the comparator 20.

A diode 14 is connected to the input node 12 to provide a diode isolated pull-up 13 for active control mode. More specifically, the anode of diode 14 is connected to the input node 12 and the cathode of diode 14 is connected to a resistor 16. The resistor 16 is connected to a voltage source 18 and is used as a current limiting resistor. The voltage source 18 acts as a bias level and is set to a value greater than the active mode logic high threshold, but less than the threshold of the comparator used for detecting the passive control mode. The active regulator control mode has a typical maximum logic high value of 4.5 volts and typical low threshold value of 2.1 volts. Therefore, the bias for the diode isolated pull-up should be about 6 volts.

An inverter with hysteresis 26 is connected to the input node 12 to receive the pulse width modulated control signal provided in an active mode. The inverter with hysteresis 26 is connected to an inverter 28 that is connected to a power-up block 30 and a counter block 32. The power-up block 30 latches on when the first logic high is detected. Prior to the first logic high, the system is in a low current quiescent sleep mode. The counter block 32 begins counting the vehicle level pull-down and release events associated with pulse width modulated control signal in the active mode. Otherwise, the regulator 10 goes back into sleep mode if the counter block 32 reaches a particular timeout period. Alternatively, the regulator may also operate in the passive mode if the comparator 20 detects a vehicle level pull-up as determined by the mode block 24.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I/We claim:

1. A voltage regulator for an automotive application, the voltage regulator comprising:
an input node configured to receive one of an active control signal and a passive control signal;
a comparator circuit in communication with the input node and configured to determine if the passive control signal has been received; and
a counter circuit in communication with the input node and configured to control a voltage set point based on the active control signal.

2. The voltage regulator according to claim 1, wherein the comparator circuit has a threshold level that is less than the lowest expected vehicle pull-up but greater than the logic levels used for the active control signal.

3. The voltage regulator according to claim 2, wherein the threshold is about 8 volts.

4. The voltage regulator according to claim 1, wherein the comparator circuit includes a comparator with a first input connected to the input node and a second input connected to a voltage source having a voltage less than the lowest expected vehicle level pull-up and greater than logic levels used for the active control signal.

5. The voltage regulator according to claim 4, wherein the voltage source has a voltage of 8 volts.

6. The voltage regulator according to claim 1, further comprising a diode isolated pull-up circuit.

7. The voltage regulator according to claim 6, wherein the diode isolated pull-up circuit includes a diode, a resistor, and a voltage source.

8. The voltage regulator according to claim 7, wherein the diode and resistor are in electrical series connection between the input node and the voltage source.

9. The voltage regulator according to claim 8, wherein the voltage source provides a bias voltage greater than the active mode logic high threshold but less than the comparator threshold used for detecting the passive control signal.

10. The voltage regulator according to claim 9, wherein the voltage source provides a bias voltage of about 6 volts.

11. The voltage regulator according to claim 6, wherein the diode isolated pull-up has a bias voltage greater than the active mode logic high threshold but less than the comparator threshold used for detecting the passive control signal.

12. The voltage regulator according to claim 11, wherein the bias voltage is about 6 volts.

13. The voltage regulator according to claim 1, further comprising a logic level inverter with hysteresis electrically connected between the input node and the counter circuit.

14. The voltage regulator according to claim 1, wherein the counter circuit is configured to enter a sleep mode if a timeout is reached after receiving an active control signal.
